(19) United States
(12) Patent Application Publication
(10) Pub. No.: US 2008/0236536 A1
(43) Pub. Date: Oct. 2, 2008

(54) Cast engine component having metallurgically bonded inserts

(75) Inventors: Jeff Alan Jensen, Dunlap, IL (US); Jose Felix Leon Torres, Dunlap, IL (US); Michael James Pollard, Peoria, IL (US); Tsu Pin Shyu, Dunlap, IL (US); Adrian Vasile Catalina, Metamora, IL (US); Jun Cai, Dunlap, IL (US); Christopher Anthony Kinney, Iuka, MS (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/730,367

(22) Filed: Mar. 30, 2007

(51) Int. Cl. F02F 1/24; B22C 9/00

(52) U.S. Cl. 123/193.5; 164/6

(57) ABSTRACT

An integral engine component is disclosed. The integral engine component may have a solid first member and a second member cast in place relative to the solid first member. A metallurgical bond may exist between the solid first member and the second member, and the melting temperature of the solid first member may be lower than the melting temperature of the second member.

### TECHNICAL FIELD

The present disclosure relates generally to a cast engine component, and more particularly, to a cast engine component having metallurgically bonded inserts.

### BACKGROUND

An internal combustion engine generally includes one or more combustion chambers that house a combustion process to produce mechanical work and a flow of exhaust. Each combustion chamber is formed from a cylinder, the top surface of a piston, and the bottom surface of a cylinder head. The cylinder head is typically fabricated from a gray iron casting or an aluminum casting having gray iron inserts. Air or an air/fuel mixture is directed into the combustion chamber by way of intake ports disposed in the cylinder head, and the resulting exhaust flow is discharged from the combustion chamber by way of exhaust ports also disposed in the cylinder head. Valves are located within the ports of the cylinder head and seal against valve seats to selectively allow and block the flows of air and exhaust.

During engine operation, the gray iron cylinder head or cylinder head inserts are exposed to high pressures and temperatures and, over time, these high pressures and temperatures can cause deterioration of the cylinder head's bottom surface, valve seats, exhaust ports, and other components of the cylinder head. As engine manufacturers are continually urged to increase fuel economy, meet lower emission regulations, and provide greater power densities, cylinder pressures and combustion gas temperatures within the combustion chamber have been increasing. Soon, gray iron cylinder heads and cylinder head inserts fabricated with today's technology may be unable to withstand the increasing pressures and temperatures.

One solution to the increasing pressures and temperatures described above is disclosed in U.S. Pat. No. 4,337,736 (the '736 patent) issued to Rasch et al. on Jul. 6, 1982. The '736 patent describes a method of producing cylinder heads having increased thermal resistance and strength. The method includes providing a preformed workpiece of a predetermined material composition, and casting on the workpiece a base material capable of producing a bond with the predetermined material composition for forming a positive connection between the workpiece and the casting material. The preformed workpiece includes a valve web, fillet or bridge, and/or a valve seat. Each workpiece has thin fusible sections, which melt when the hot base material is cast over them. The base material is a molten cast iron generally used for cylinder heads. The work piece is an alloy made up in percentages by weight of up to 3.0% C, 1.7-2.2% Si, 1.0-1.5% Mn, 18-22% Ni, 1.8-2.4% Cr, 0.1% Nb, 0.05% Mg, and the balance of Fe. This alloy has improved heat resistance and strength over the base cast iron material.

Although the method of the '736 patent may be used to fabricate cylinder heads with improved heat resistance and strength, it may be costly and its applicability may still be limited. Specifically, because each of the workpieces described in the '736 patent must be specially designed to have thin fusible sections that melt during the casting process, the cost of these workpieces may be excessive. And, the cast material poured over the workpieces may cool too quickly upon contacting the workpiece, causing the development of undesirable carbides within the bonded interface. Further, because melting of the workpiece only occurs at the thin fusible sections, the bond formed thereby may be insufficient. In addition, the alloy disclosed in the '736 patent may still have material properties inadequate to withstand the pressures and temperatures of today's engines.

The disclosed cylinder head is directed to overcoming one or more of the problems set forth above.

### SUMMARY OF THE DISCLOSURE

In one aspect, the present disclosure is directed to an integral engine component. The integral engine component may include a solid first member and a second member cast in place relative to the solid first member. A metallurgical bond may exist between the first member and second member, and the melting temperature of the solid first member may be lower than the melting temperature of the second member.

In another aspect, the present disclosure is directed to another integral engine component. The integral engine component may include a solid first member and a second member cast in place relative to the solid first member. The solid first member may be heated to less than the melting temperature of the solid first member prior to casting in place of the second member such that an entire surface of the solid first member in contact with the second member melts when the second member is cast in place.

In another aspect, the present disclosure is directed to a method of fabricating an integral engine component. The method may include forming a mold and depositing a solid first member within the mold. The method may also include pouring a liquefied alloy into the mold such that a portion of the solid first member in contact with the liquefied alloy melts. The melting temperature of the solid first member may be lower than the melting temperature of the liquefied alloy.

In yet another aspect, the present disclosure is directed to another method of fabricating an integral engine component. This method may include forming a mold and depositing a solid first member into the mold. The method may also include heating the solid first member to less than the melting temperature of the solid first member, and pouring a liquefied alloy into the mold such that an entire surface of the heated solid first member in contact with the liquefied alloy melts when in contact with the liquefied alloy.

### BRIEF DESCRIPTION OF THE DRAWINGS

FIG. 1 is a pictorial illustration of an exemplary disclosed engine;

FIG. 2 is a pictorial illustration of an exemplary disclosed cylinder head for use with the engine of FIG. 1;

FIG. 3A is cross-sectional illustration of an exemplary insert associated with the cylinder head of FIG. 2; and

FIG. 3B is cross-sectional illustration of another exemplary insert associated with the cylinder head of FIG. 2.

### DETAILED DESCRIPTION

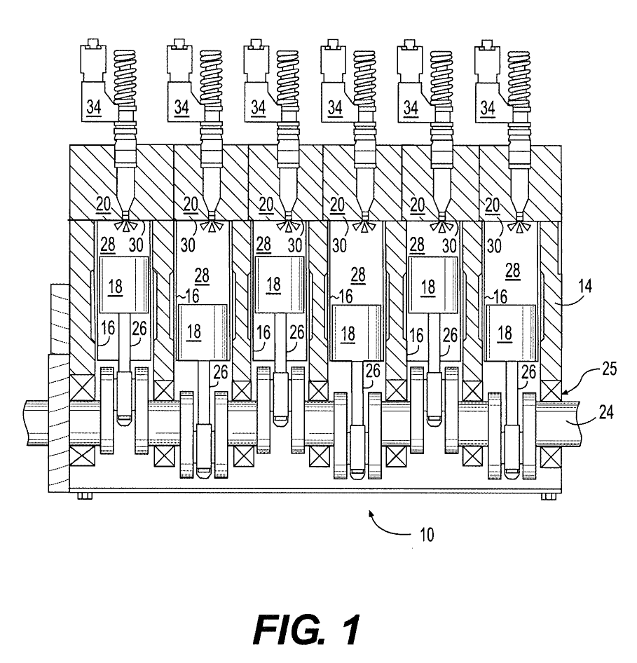

FIG. 1 illustrates an exemplary engine 10. For the purposes of this disclosure, the engine 10 is depicted and described as a four-stroke diesel engine. One skilled in the art will recognize, however, that engine 10 may be any other type of internal combustion engine such as, for example a diesel engine, a gasoline engine or a gaseous fuel-powered engine. Engine 10 may include an engine block 14 that defines a plurality of cylinders 16, a piston 18 slidably disposed within each cylinder 16, and a cylinder head 20 associated with each cylinder 16. The engine 10 may also include a crankshaft 24 that is rotatably supported within engine block 14 by way of a plurality of journal bearings 25. A connecting rod 26 may connect each piston 18 to crankshaft 24 so that a sliding motion of piston 18 within each respective cylinder 16 results in a rotation of crankshaft 24. The cylinder 16, piston 18, and cylinder head 20 together may form a combustion chamber 28.

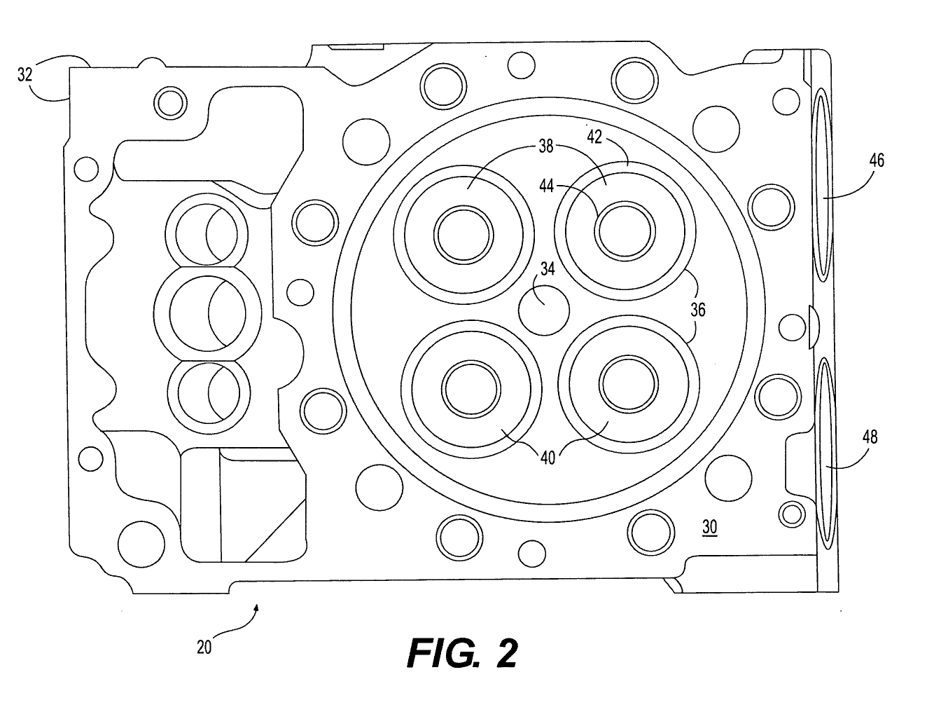

Referring to FIG. 2, cylinder head 20 may include a bottom deck, or firedeck surface 30, a plurality of side surfaces 32 and a top surface (not shown). Firedeck surface 30 of cylinder head 20 may be fastened to engine block 14 (referring to FIG. 1) of engine 10, in a typical manner. Firedeck surface 30 of cylinder head 20 may include a fuel injector opening 34 and two or more valve openings 36. As illustrated, valve openings 36 may include a pair of exhaust valve openings 38 and a pair of intake valve openings 40. Valve openings 36 may be evenly spaced about fuel injector opening 34. Each valve opening 36 may include a valve seat 42 and a valve guide 44. A passage (not shown) may be defined within the cylinder head 20 extending from each valve opening 36 to a respective one of an exhaust port 46 and an intake port 48. The exhaust and intake ports 46, 48 may be defined in one of the side surfaces 32 of the cylinder head 20. Internally, cylinder head 20 may include a plurality of fluid passages (not shown). The fluid passages include, for example, a coolant jacket and lubrication passages. The coolant jacket and lubrication passages may function in a conventional fashion.

Valve seats 42, valve guides 44, firedeck surface 30 and exhaust port 46 may, in a typical arrangement, be cast integral to the cylinder head 20 and then may be machined to precise dimensions during a second process. However, in the embodiments of this disclosure, different material properties for these components may be desirable.

As one example, the material chosen to cast the bulk of cylinder head 20 may have an oxidation resistance too low to sustain a load that may, in some situations, be as great as 22 MPa and 400° C. within combustion chamber 28 or at exhaust port 46. Thus, a second material of greater thermal strength may be desirable for use as an insert in valve seats 42, valve guides 44, firedeck surface 30 and exhaust port 46. The second material may be inappropriate for use throughout cylinder head 20 due to cost and machinability, but when strategically located, the inserts may improve the reliability of the thermally loaded components and increase the overall service life of cylinder head 20. A further example may use the thermal conduction properties of a second material insert in cylinder head 20 to insulate heat from combustion chamber 28, thereby increasing the efficiency of engine 10. The use of a stronger insert with better oxidation resistance for insulating combustion heat may eliminate the need for the liquid cooling throughout cylinder head 20, thereby reducing the design, manufacturing and maintenance complexity of cylinder head 20.

In general, the base portion of cylinder head 20 (i.e. that portion of cylinder head 20 consuming the largest volume) may be fabricated from an inexpensive and easily machinable material such as, for example, gray cast iron. Gray cast iron may have a melting temperature of about 1150-1160° C., a Brinell hardness number of about 183-234 and an ultimate tensile strength of about 280-360 MPa. Firedeck surface 30, valve seats 42, valve guides 44 and exhaust port 46 and others may be fabricated from a material having improved properties, as compared to gray cast iron. For example, these components may be fabricated from any one of the materials listed in Table 1 below.

TABLE 1

| | | | | Ultimate |
|---|---|---|---|---|
| | | Melting | | Tensile |
| | | Temp. | | Strength |
| Description | Composition (Wt %) | (° C.) | Hardness | (Mpa) |
| D-2B Ni-Resist | 20Ni—3.5Cr—3C—2.5Si—0.8Mn—0.030Mg—balance Fe | 1260 | 180 | 400 |
| | | | Brinell | |
| D-5S Ni-Resist | 35Ni—5Si—2C—2Cr—0.030Mg—balance Fe | 1230 | 160 | 450 |
| | | | Brinell | |
| High-Si—Mo | 4Si—3.2C—0.6Mo—0.030Mg—balance Fe | 1150 | 220 | 480 |
| Ductile Iron | | | Brinell | |
| 430 Ferritic | 16Cr—1.0Si Max —1.0Mn Max—0.12C—balance Fe | 1425 | 85 HRB | 517 |
| Stainless | | | | |

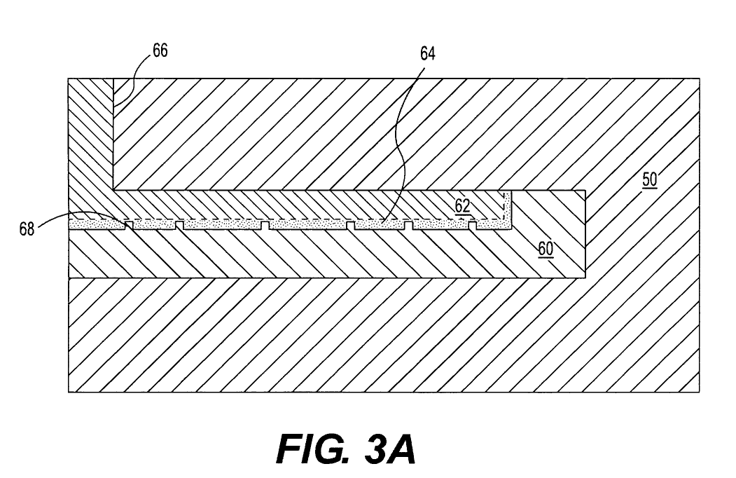

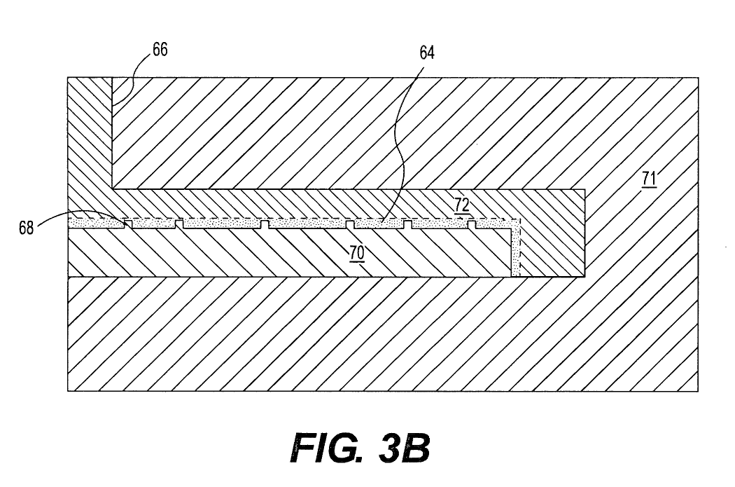

FIG. 3A illustrates an exemplary process for joining components of dissimilar materials in a cross section of cylinder head 20. The setup for this process may include a mold 50, a solid cylinder head base 60 having near final form and being placed into mold 50 and a liquefied cast insert 62 poured into mold 50 and received by solid cylinder head base 60. When liquefied cast insert 62 is poured into mold 50, it may be bound by solid cylinder head base 60 on its internal surfaces and mold 50 on its external surfaces such that when cooled, insert 62 may have near final form.

Mold 50 may be a two-part mold containing a cavity in which solid cylinder head 60 is placed and that receives liquefied insert 62. Mold 50 may be constructed of sand or other suitable material in a typical fashion and contain features that allow for the control of insert microstructure and a boundary layer 64 (i.e. that area formed between insert 62 and base 60). Areas that cool quickly may have a fine grain structure and areas that cool slowly may have a coarse grain structure. Features that slow cooling may include a riser 66, a cavity within mold 50 that contains an excess reservoir of the liquefied alloy for the purpose of feeding additional liquefied alloy into the cavity as liquefied insert 62 solidifies and shrinks. In addition to slowing the cooling process, riser 66 may prevent undesirable voids in the casting. To increase cooling rates, chills (not shown) or heat sinks within mold 50, may be placed in areas where rapid cooling is desirable. Chills may, for example, be constructed of copper or iron. In order to increase area of metallurgical bonding, solid cylinder head base 60 may be designed to include mechanical grips 68 that increase the surface area of boundary layer 64.

Although mechanical connection between cylinder head base 60 and cast insert 62 may be adequate for some situations, a metallurgical bond may be required for others. To create this metallurgical bond, the melting temperature of insert 62 may be higher than that of solid cylinder head base 60 such that an entire surface of solid cylinder head base 60 in contact with insert 62 may melt during casting of insert 62. To facilitate melting of solid cylinder head base 60, mold 50 and solid cylinder head base 60 may be preheated to a temperature that approaches the melting temperature of the material used in solid cylinder head base 60. For example, mold 50 and solid cylinder head base 60, which may formed of gray iron, may be placed in an induction furnace and preheated via electromagnetic induction to about 850° C.-900° C. prior to the casting of insert 62. The melted portion of solid cylinder head base 60 may combine with liquefied insert 62 forming the mixed boundary layer 64. As insert 62 and solid cylinder head base 60 cool, a metallurgical bond between the two bodies may form at boundary layer 64.

FIG. 3B, illustrates an alternative method for joining components of dissimilar materials. In this embodiment, a solid insert 70 having fully formed external features (i.e. valve seat, valve guide, firedeck surface, etc.) may be placed within mold 71 to receive a liquid cast cylinder head base 72. Solid insert 70 may be heated to form boundary layer 64 with liquid cast cylinder head 72, as liquid cast cylinder head 72 is poured into mold 71 and received by solid insert 70. When cooled and removed from mold 71, insert 70 and cast cylinder head 72 may be metallurgically bonded and have near final form.

### INDUSTRIAL APPLICABILITY

The method of fabrication presently disclosed may be applicable to a wide variety of engine components including, for example, a cylinder head having cast in place firedeck surface, valve seats, valve bridge, valve guides and/or valve ports; and an engine block having cast in place cylinder liners, journal bearings or other features. The disclosed integral engine component may improve the thermal resistance and strength of the engine thereby allowing for greater pressures and temperatures within the combustion chamber, at an overall lower cost. The method for casting an engine component having metallurgically bonded inserts will now be described in detail with reference to FIG. 3A.

The creation of an engine component having metallurgical bonded inserts may require a two-step composite casting process. In one embodiment, the first member, for example a gray iron cylinder head 60 may be cast into a mold (not shown) or otherwise fabricated such that areas subject to high stress, for example the cylinder head's firedeck surface, valve seats and exhaust ports, are not fully formed (i.e. those areas designated to receive a liquid insert have voids when initially fabricated). The surfaces of the unformed areas may include mechanical grips 68 or various shapes and sizes that improve the resulting metallurgical bond by increasing the wetted perimeter between solid cylinder head base 60 and insert 62. Solid cylinder head base 60 may be placed into mold 50, which may be designed such that a liquefied alloy may be injected or otherwise poured into mold 50 and internally received by cylinder head 60 to form the areas subject to high stress. Gray iron cylinder head 60 may be pre-heated to above about 850° C. or 900° C. prior to receiving the liquefied alloy. The heating may, for example, be achieved with an induction oven (not shown), in which cylinder head 60 and mold 50 may be placed. Liquefied insert 62 composed of a second alloy with a higher melting temperature than the gray iron cylinder head, for example 430 Ferritic stainless steel having a melting temperature of 1425° C. or High-Si—Mo ductile iron with a melting temperature of 1150° C. may be injected into mold 50 and received by gray iron cylinder head 60. Liquefied insert 62 may, when poured mold 50, melt the cast gray iron in the area of contact therewith and as cooling occurs, a metallurgical bond may form between the two members along their common surfaces.

Several advantages over the prior art may be associated with the integral engine component of the present disclosure. Specifically, the disclosed process may allow flexibility in design constraints such as shape, size and material properties. Such flexibility allows for the selection of parameters that will lead to desirable cooling rates in the workpieces ensuring bonding across the entire contact region and the formation of desirable intermetallic bonds. The advantages provided by the present disclosure may allow the construction of components capable of withstanding the pressures and temperatures of today's engines. The selected use of material inserts may allow the opportunity to use materials with improved thermal properties without the increased cost associated with their use throughout the entire engine block or cylinder head. Furthermore, the flexibility afforded by the present disclosure may allow selection of materials with desirable thermal conduction properties and their placement throughout the cylinder head in a manner that may eliminate the need for the fluid passages that conventionally function in a cooling circuit capacity. The present disclosure may achieve these advantages without requiring specific and expensive insert geometry to ensure melting at certain locations, as an entire periphery may be melted due to the elevated temperatures of the base material and proper material selection.

It will be apparent to those skilled in the art that various modifications and variations can be made to the disclosed cylinder head. Other embodiments will be apparent to those skilled in the art from consideration of the specification and practice of the disclosed cylinder head. It is intended that the specification and examples be considered as exemplary only, with a true scope being indicated by the following claims and their equivalents.

1. An integral engine component, comprising:
a solid first member; and
a second member cast in place relative to the solid first member such that a metallurgical bond exists between the solid first member and the second member, wherein the melting temperature of the solid first member is lower than the melting temperature of the second member.

2. The integral engine component of claim 1, wherein the solid first member has a volume greater than the volume of the second member and the second member is received within the solid first member.

3. The integral engine component of claim 1, wherein the metallurgical bond extends along the entire surface of the solid first member in contact with the second member.

4. The integral engine component of claim 1, wherein the second member has an oxidation resistance greater than the oxidation resistance of the solid first member.

5. The integral engine component of claim 1, wherein the second member has a strength greater than the strength of the solid first member.

6. The integral engine component of claim 1, wherein the solid first member is heated before the second member is cast in place.

7. The integral engine component of claim 1, wherein the solid first member is composed of gray iron.

8. The integral engine component of claim 7, wherein the second member is composed of stainless steel.

9. The integral engine component of claim 8, wherein the gray iron is heated above about 850° C. before casting the stainless steel in place.

10. The integral engine component of claim 7, wherein the second member is composed of high Si-Mo ductile iron alloy.

11. The integral engine component of claim 10, wherein gray iron is heated above about900° C. before casting the high Si-Mo ductile iron alloy in place.

12. An integral engine component, comprising:
a solid first member; and
a second member cast in place relative to the solid first member,
wherein the solid first member is heated to less than the melting temperature of the solid first member prior to casting in place of the second member such that an entire surface of the solid first member in contact with the second member melts when the second member is cast in; and
wherein the second member has at least one of an oxidation resistance, strength, and melting temperature greater than the solid first member.

13. The integral engine component of claim 12, wherein the solid first member has a volume greater than the volume of the second member and the second member is received within the solid first member.

14. (canceled)

15. The integral engine component of claim 12, wherein the solid first member is composed of gray iron and the second member is composed of stainless steel.

16. The integral engine component of claim 12, wherein the solid first member is composed of gray iron and the second member is composed of high Si-Mo ductile iron.

17. A method of fabricating an integral engine component, comprising:
forming a mold;
depositing a solid first member within the mold; and
pouring a liquefied alloy into the mold such that a portion of the solid first member in contact with the liquefied alloy melts, wherein the melting temperature of the solid first member is lower than the melting temperature of the liquefied alloy.

18. The method of claim 17, wherein the solid first member has a volume greater than the volume occupied by the liquefied alloy and the liquefied alloy is internally received by the solid first member.

19. The method of claim 17, wherein an entire surface of the solid first member in contact with the liquefied alloy melts when in contact with the liquefied alloy.

20. The method of claim 17, further including heating the solid first member before the liquefied alloy is poured into the mold.

21. The method of claim 20, wherein the solid first member is composed of gray iron and the liquefied alloy is composed of stainless steel.

22. The method of claim 21, wherein heating includes heating the gray iron above about 850° C.

23. The method of claim 20, wherein the solid first member is composed of gray iron and the liquefied alloy is composed of high Si-Mo ductile iron.

24. The method of claim 23, wherein heating includes heating the gray iron above about 900° C.

25. A method of fabricating an integral engine component, comprising:
forming a mold;
depositing a solid first member into the mold;
heating the solid first member to less than the melting temperature of the solid first member; and
pouring a liquefied alloy into the mold such that an entire surface of the heated solid first member in contact with the liquefied alloy melts when in contact with the liquefied alloy, wherein the liquefied alloy has at least one of an oxidation resistance, strength, and melting temperature greater than the solid first member.

26. The method of claim 25, wherein the solid first member has a volume greater than the volume occupied by the liquefied alloy and the liquefied alloy is internally received by the solid first member.

27. (canceled)

28. The method of claim 25, wherein the solid first member is composed of gray iron and the liquefied alloy is composed of stainless steel.

29. The method of claim 25, wherein the solid first member is composed of gray iron and the liquefied alloy is composed of high Si-Mo ductile iron.
